(19) United States
(12) Patent Application Publication
(10) Pub. No.: US 2025/0106011 A1
(43) Pub. Date: Mar. 27, 2025

(54) GENERATING SHARED PRIVATE KEYS

(71) Applicant: nChain Licensing AG, Zug (CH)

(72) Inventor: Michaella PETTIT, London (GB)

(21) Appl. No.: 18/832,306

(22) PCT Filed: Jan. 3, 2023
(86) PCT No.: PCT/EP2023/050084

§ 371 Date: Jul. 23, 2024

(30) Foreign Application Priority Data
Jan. 25, 2022 (GB) 2200898.1

(51) Int. Cl. H04L 9/08; H04L 9/06; H04L 9/30

(52) U.S. Cl. CPC H04L 9/085; H04L 9/0643; H04L 9/0869; H04L 9/30

(57) ABSTRACT

A computer-implemented method of generating shares of child private keys, and wherein the method is performed by a first participant of the group and comprises:
receiving, from a coordinator, a first share of a master private key, wherein the master private key is generated based on a first portion of a hash of a seed value;
receiving, from a coordinator, a master chain code for the master private key, wherein the master chain code is generated based on a second portion of the hash of the seed value;
receiving, from a coordinator, a master public key corresponding to the master private key;
generating one or more first shares of one or more respective child private keys, wherein each first share of the respective child private key is generated based on the first share of the master private key, and a first portion of a hash of i) the master chain code, ii) the master public key and iii) a respective key index.

### CROSS REFERENCE TO RELATED APPLICATIONS

This application is the U.S. National Stage of International Application No. PCT/EP2023/050084 filed on Jan. 3, 2023, which claims the benefit of United Kingdom Patent Application No. 2200898.1, filed on Jan. 25, 2022, the contents of which are incorporated herein by reference in their entireties.

### TECHNICAL FIELD

The present disclosure relates to a method of enabling the generation of a plurality of shared private keys, or more specifically, respective shares of respective shared private keys, and to a method of generating respective shares of respective shared private key.

### BACKGROUND

In general, a shared secret may be used to share a data item that is distributed amongst a group of participants. Each participant has a different share of the secret. Normally, the secret can only be reconstructed when a certain number (referred to as the “threshold”) of participants make their respective shares available, e.g. to be combined together to calculate the secret.

Public-key cryptography is a type of cryptographic system that uses pairs of keys: private keys which are known only to the owner of the private key, and public keys which are generated based on the corresponding private key and which may be disseminated without compromising the security of the private key.

Public-key cryptography enables a sender to encrypt a message using a recipient's public key (i.e. the public key corresponding to a private key known only to the recipient). The encrypted message can then only be decrypted using the recipient's private key.

Similarly, a sender can use their own private key to sign a message, e.g. to prove that the message is being sent by the sender, and/or to indicate that the sender agrees with the message. The signer (i.e. the party generating the signature) uses their private key to create a digital signature based on the message. Creating a digital signature based on a message means supplying the message and private key to a function that generate the signature based on both the message and private key. The signature is added to (e.g. tagged onto) the message or otherwise associated with the message. Anyone with the signer's corresponding public key can use the same message and the digital signature on the message to verify whether the signature was validly created, i.e. whether the signature was indeed made using the signer's private key. As well as ensuring the authenticity of a message, digital signatures also ensure the integrity and non-repudiation of the message. That is, a digital signature can be used to prove that a message has not been changed since it was signed with the signature, and that the creator of a signature cannot deny in the future that they created the signature.

A digital signature scheme typically involves three procedures, i.e. algorithms. A key generation algorithm is used to generate a random private key and a corresponding public key. A signing algorithm is used to generate a signature based on a message and the private key. A verification algorithm is used to verify, given a public key and the message, whether the signature has been generated using the corresponding private key and according to the signing algorithm.

A common use of a shared secret is as a shared private key of a private-public key pair. That is, the private key may be distributed amongst a group of participants such that no single participant has access to the private key. Therefore no single participant can generate a valid signature of a message. Instead, some or all of the participants must together generate the private key in order for the signature to be generated.

Instead of the participants sharing their private key shares in order to generate a signature, they may instead use a threshold signature scheme. A threshold signature scheme allows a threshold number of participants in a group to create a digital signature based on a message using individual shares of a shares private key, without the private key being made available to any one participant. Here, a digital signature is a signature which is generated based on the message to be signed. In such a scheme, the signature can only be created if the threshold number of participants agree to generate the signature on the message. Any attempt to generate a signature using a smaller number of participants will not generate a valid signature. Therefore, a valid signature by the group (i.e. one generated using the message and the shared private key) provably had the threshold number of people agree to generate the signature. This also implies that any adversary needs to obtain the threshold number of shares of the private key to forge a signature with that private key.

### SUMMARY

As set out above, a shared secret may correspond to a shared private key. In many scenarios it is recommended that a given private key should not be used more than once. In addition, due to the nature of public-private keys, and in particular the difficulty in deriving the private key from a corresponding public key, it is essential that a private key is not lost.

Therefore it would be desirable to be able to generate a series of “shared private keys” to prevent key reuse (i.e. to prevent a group of users having to re-use the same shared private key) and enable key recovery (i.e. to allow a group of users to reconstruct a shared private key).

It is known to generate a structure of parent keys and child keys, where each child key is linked back to (i.e. derivable from) a parent key and ultimately, each key in the structure is linked back to (i.e. derivable from) a master private key. It would be desirable to replicate the same structure with the shared private keys.

One challenge that is faced when attempting to derive such a structure of shared private keys is how to derive child keys (or shares thereof) based on the master private key, without revealing the master private key and thus compromising the security of each key in the structure.

According to one aspect disclosed herein, there is provided a computer-implemented method of generating shares of child private keys, and wherein the method is performed by a first participant of the group and comprises: receiving, from a coordinator, a first share of a master private key, wherein the master private key is generated based on a first portion of a hash of a seed value; receiving, from a coordinator, a master chain code for the master private key, wherein the master chain code is generated based on a second portion of the hash of the seed value; receiving, from a coordinator, a master public key corresponding to the master private key; generating one or more first shares of one or more respective child private keys, wherein each first share of the respective child private key is generated based on the first share of the master private key, and a first portion of a hash of i) the master chain code, ii) the master public key and iii) a respective key index.

According to another aspect disclosed herein, there is provided a computer-implemented method for enabling participants of a group to generate shares of child private keys, and wherein the method is performed by a coordinator and comprises: generating a master private key based on a first portion of a hash of a seed value; generating a master chain code for the master private key, wherein the master chain code is generated based on a second portion of the hash of the seed value; generating a master public corresponding to the master private key; using a secret sharing scheme to make a respective share of the master private key available to each respective participant; and making the master chain code available to each participant, wherein each participant is configured to generate a respective share of a first child private key based on the respective share of the master private key, and a first portion of a hash of i) the master chain code, ii) the master public key and iii) a first key index.

The coordinator (i.e. a dealer) inputs at least a secret seed into a hash function, e.g. a HMAC function. A first portion of the resulting hash is used as the master private key. A second portion of the same hash is used as the chain code for the master private key. The coordinator also generates a master public key, e.g. using an elliptic curve generator point.

The coordinator shares the chain code and the master public key with each participant. That is, the same data (master chain code and master public key) is sent to each participant. The coordinator also splits the master private key into shares and distributes a different share to each participant. The coordinator may use Shamir's secret sharing scheme to distribute the master private key shares. Each participant is thus provided with a respective share of the master private key, which is used to generate respective shares of child private keys.

Since each participant has a share of the same master private key, they can each derive shares of the same child private key(s). Therefore the group of participants can use different private keys to, for example, generate signature shares for signing messages, or for encryption and decryption of messages. This achieves the first aim of preventing re-use of a shared private key. Moreover, since each participant has a share of the master private key and a share of the child private keys, the master private key and child keys can be recovered, if lost, by reconstructing the required key with a threshold number of key shares. Thus the second aim of enabling key recovery of shared private keys is met.

A key structure, sometimes also referred to as a hierarchical deterministic (HD) wallet, is a collection of deterministically linked private keys, where at least some of the keys are associated with different levels and positions within the hierarchical structure. For instance, the master private key sits at the top of the hierarchy (i.e. level 0), with one or more child keys at the next level (i.e. level 1). Each child key at level 1 is linked to the master private key. Each child key at level 1 may be linked to one or more respective sets of child keys at level 2. Therefore whilst being children of the master key, the child keys of level 1 may also be parents to child keys of level 2. It will be appreciated that a HD wallet may contain any number of levels and keys. Embodiments of the present disclosure enable a “shared wallet” of private key shares to be generated, where each private key can be traced back to (i.e. linked to) the master private key share. The shared wallet may take a form similar to a traditional HD wallet. Instead of each participant having a wallet of private keys, they now have a wallet of private key shares. When required, each participant can access their respective key share at the same level and position of the key structure in order to e.g. generate a signature share.

### BRIEF DESCRIPTION OF THE DRAWINGS

To assist understanding of embodiments of the present disclosure and to show how such embodiments may be put into effect, reference is made, by way of example only, to the accompanying drawings in which:

FIG. 1 is a schematic block diagram of a system for generating shared private keys, and

FIG. 2 schematically represents hierarchical deterministic key structure,

FIG. 3 is a flow diagram illustrating an example method for generating shared private keys from the perspective of a coordinating party, and

FIG. 4 is a flow diagram illustrating an example method for generating shared private keys from the perspective of a participant,

FIG. 5 is a flow diagram illustrating an example signature generation method according to some embodiments of the present invention.

### DETAILED DESCRIPTION OF EMBODIMENTS

### 1. Cryptographic Principles

Whilst the following examples are described in terms of elliptic curve cryptography, the invention is not limited to any one particular cryptographic scheme and may in general be applied to any cryptographic scheme, e.g. RSA or other public key cryptography schemes.

### 1.1 Elliptic Curve Groups

An elliptic curve E satisfies the equation:

$${y}^{2} = {x}^{3} + a x + b mod p$$

where a, b ∈ [symbol] and a, b are constants satisfying 4a³+27b²≠0. The group over this elliptic curve is defined to be the set of elements (x,y) satisfying this equation along with the point at infinity [symbol] , which is the identity element. The group operation on the elements in this group is called elliptic curve point addition and denoted by +. This group is denoted by E( [symbol] ) and its order by n.

This group operation can be used to define another operation on the element called point multiplication denoted by·. For a point G ∈ E( [symbol] ) and a scalar k ∈ [symbol] , the point k·G is defined to be the point G added to itself k times.

In elliptic curve cryptography, a private key is defined to be a scalar k ∈ [symbol] ,\{0} where [symbol] ,\{0} is notation for the set {1, . . . , n−1}., and the corresponding public key is the point k·G on an elliptic curve. For instance, in some blockchain protocols, the elliptic curve is chosen to be the secp256k1 elliptic curve, and the values a, b, and p are completely specified by this curve. The order n of this group has been calculated given these values, which in the case of this curve is a prime, and the secp256k1 standard also specifies a point G which is to be used as the generator of this group.

### 1.2 Elliptic Curve Digital Signature Algorithm

In order to create a signature on a message msg, with the private key a, the following steps are taken:
1. Calculate the message digest e=hash(msg), where may be any hash function. For instance, in some examples hash(msg)=SHA256(SHA256(msg))where SHA256(▪) is the SHA-256 hash function. Note that instead the message may be hashed only once, or more that two times with the same or different hash functions.
2. Chose a random integer k ∈ {1, . . . , n−1}, where n is the order of the elliptic curve, e.g. the secp256k1 curve. In the following, k is referred to as the ephemeral private key.
3. Calculate the ephemeral public key corresponding to this ephemeral private key k·G=(Rₓ, R_{y}).
4. Calculate r=Rₓ mod n. If r=0, return to step 2.
5. Calculate the multiplicative inverse of the ephemeral key k⁻¹ mod n.
6. Calculates=k⁻¹(e+ar) mod n. If s=0, return to step 2.
7. The signature on the message msg is (r,s).

The ephemeral key must be kept secret, otherwise the private key can be calculated, given a message and signature. Additionally, each time a signature is generated, a different ephemeral key must be used. If this is not the case, it is possible to derive the private key a given two different signatures and their corresponding messages.

Given a message msg, a public key P=a·G, and corresponding signature (r,s), then one can verify the signature by completing the following steps:
1. Calculate the message digest e=hash(msg), e.g. e=SHA256(SHA256(msg)).
2. Calculate the multiplicative inverse s⁻¹ of s modulo n.
3. Calculate j₁=es⁻¹ mod n and j₂=rs⁻¹ mod n.
4. Calculate the point Q=j₁·G+j₂·P.
5. If Q= [symbol] , the point at infinity, the signature is invalid.
6. If Q≠ [symbol] , then let Q:=(Qₓ, Q_{y}), and calculate u=Qₓ mod n. If u=r, the signature is valid.

In threshold signature schemes, this private key a is split into key shares that are distributed amongst participants in a threshold scheme group.

### 1.3 Joint Verifiable Random Secret Sharing

Assume that N participants want to create a joint secret that can only be regenerated by at least (t+1) of the participants in the scheme. To create the shared secret, the following steps are taken:
1. The participants agree on the unique label i for each participant. Each participant i generates (t+1) random numbers

$${a}_{i j} {∈}_{R} {ℤ}_{n} ∖ \{ 0 \} , ∀ j = 0 , … , t ,$$

where ∈_{R} means a randomly generated element of the set [symbol] \{0} where [symbol] \{0} is notation for the set {1, . . . , n−1}. Then each participant has a secret polynomial of order t

$${f}_{i} ( x ) = {a}_{i 0} + {a}_{i 1} x + … + {a}_{i t} {x}^{t} mod n ,$$

for i=1, . . . , N. Note that we omit the mod n notation from now on, and it is assumed that all arithmetic operations over integers are done modulo n.
2. Each participant i sends the value fᵢ(j) to participant j e.g. using a secure communication channel with participant j only.
3. Each participant i calculates their own private secret share of a shared secret polynomial as

$${a}_{i} := {\sum }_{j = 1}^{N} {f}_{j} ( i ) .$$

A shared secret share is a point with the form (i, a₁), where i is the participants label in the scheme. This method for creating a secret share of a, as described in steps 1-3, is denoted herein by aᵢ=JVRSS(i) for participant i. Note that “JVRSS” typically stands for “Joint verification random secret sharing” and includes steps 4 and 5 as well. However, throughout this document JVRSS is taken to mean performing at least steps 1 to 3, where steps 4 and 5 are optional steps.

Now that the participants have generated a shared polynomial, they can each verify that the other participants have shared the correct information to all participants, and that all participants have the same shared polynomial. This is done in the following way.
4. Each participant i broadcasts to all participants the obfuscated coefficients

$${a}_{ik} \cdot G ,$$

fork=0, . . . , t.
5. Each participant i checks that each participant j has correctly calculated the polynomial point fⱼ(i) by calculating fⱼ(i)·G and verifying that

$${f}_{j} ( i ) \cdot G = {\sum }_{k = 0}^{t} {i}^{k} ( {a}_{jk} \cdot G )$$

$$∀ j = 1 , … , N .$$

If all participants find that this equation holds for each polynomial, then the group can collectively be sure that they have all created the same shared polynomial.

### 1.4 Reconstructing a Shared Secret

Assume a participant wants to reconstruct a shared secret a which is the zeroth order of a shared polynomial. Given (t+1) points on this polynomial of the form

$$( 1 , {a}_{1} ) , … , ( ( t + 1 ) , {a}_{t + 1} ) ,$$

then to find the shared secret a, one calculates

$$interpolate ( {a}_{1} , … , {a}_{t + 1} ) = ( {\sum }_{l = 1}^{t + 1} {a}_{l} {\prod }_{{1 \leq j \leq ( t + 1 ) ,}_{j \neq l}} ( - j ) {( l - j )}^{- 1} ) = a ,$$

which is derived from a general formula known as “Lagrange Interpolation”.

### 1.5 Public Key Calculation

Given the N zeroth-order private polynomial coefficient public keys aᵢₒ·G for j=1, . . . , N shared in step 4 of JVRSS, each participant calculates the shared public key P using

$$P = a \cdot G = {\sum }_{j = 1}^{N} {a}_{j 0} \cdot G ,$$

corresponding to the shared secret a.

### 1.6 Addition of Shared Secrets

To calculate the addition of two shared secrets that are shared amongst a group of N participants, where each secret polynomial has order t, without any entity knowing the individual secrets, the following steps are taken:
1. Generate the first shared secret a, where participant i's share is given by aᵢ=JVRSS(i) for i=1, . . . , N with a threshold of (t+1).
2. Generate the second shared secret b, where participant i's share is given by bᵢ=JVRSS(i), with a threshold of (t+1).
3. Each participant i calculates their own additive share

$${v}_{i} = {a}_{i} + {b}_{i} mod n .$$

4. All participants broadcast their additive share vi to all other participants.
5. Each participant interpolates over at least (t+1) of the shares vi to calculate

$$v = interpolate ( {v}_{1} , … , {v}_{t + 1} ) = a + b .$$

This method for the addition of shared secrets is denoted by ADDSS(i) for participant i, which results in each participant i knowing v=(a+b).

### 1.7 Product of Shared Secrets

To calculate the product of two shared secrets that are both shared amongst a group of N participants, where each secret polynomial has order t, the group takes the following steps:
1. Generate the first shared secret a, where participant i's share is given by aᵢ=JVRSS(i) for i=1, . . . , N. The shared secret polynomial has order t, meaning (t+1) participants are required to recreate it.
2. Generate the second shared secret b, where participant i's share is given by bᵢ=JVRSS(i), and the shared secret polynomial again has order t.
3. Each participant calculates their own multiplicative share μᵢ using

$${μ}_{i} = {a}_{i} {b}_{i} .$$

4. All participants broadcast their multiplicative share μᵢ to all other participants.
5. Each participant interpolates over at least (2t+1) of the shares μᵢ at 0 to calculate

$$μ = interpolate ( {μ}_{1} , … , {μ}_{2 t + 1} ) = ab .$$

This method for calculating the product of two shared secrets is denoted herein by μ=ab=PROSS(i) for participant i.

### 1.8 Inverse of a Shared Secret

In order to calculate the inverse of a shared secret a, the following steps are taken:
1. All participants calculate the product of shared secrets PROSS(i), the result of which is μ=ab mod n.
2. Each participant calculates the modular inverse of μ which results in

$${μ}^{- 1} = {( ab )}^{- 1} mod n .$$

3. Each participant i calculates their own inverse secret share by calculating

$${a}_{i}^{- 1} = {μ}^{- 1} {b}_{i} .$$

This method for calculating the inverse of shared secrets is denoted by aᵢ⁻¹=INVSS(i) for participant i.

### 1.9 Shared Private Key Generation and Verification

To calculate a shared private key a between N≥2t+1 participants, t+1 of which are required to create a signature, the participants execute JVRSS with a threshold of t+1 and public key calculation as described above. The result is that every participant i=1, . . . , N has a private key share aᵢ and the corresponding shared public key P=(a·G).

### 1.10 Ephemeral Key Shares Generation

To generate ephemeral key shares and the corresponding r, as is required in a signature, a group of size N with a shared private key a of threshold (t+1) execute the following steps:
1. Generate the inverse share of a shared secret kᵢ⁻¹=INVSS(i), where (t+1) shares are required to recreate it.
2. Each participant calculates

$$( x , y ) = {\sum }_{i = 1}^{N} ( {k}_{i 0} \cdot G ) ,$$

using the obfuscated coefficients shared in the verification of kᵢ, then they calculate

$$r = x mod n .$$

3. Each participant i stores (r, kᵢ⁻¹).

### 1.11 Non-Optimal Signature Generation

Assume that at least 2t+1 participants would like to create a signature on a message, and one of the participants chooses to coordinate this. In order to create a signature by a group with the shared private key α, the following steps are taken.
1. The coordinator requests a signature on the message from at least 2t+1 participants.
2. Each participant i recovers the ephemeral key (r, kᵢ⁻¹) calculated in the previous section. All users must use a share corresponding to the same ephemeral key.
3. Each participant calculates the message digest e=SHA-256(SHA-256(message)).
4. Each participant i calculates their own signature share sᵢ:
   sᵢ=kᵢ⁻¹(e+aᵢr) mod n,
   where αᵢ is their private key share.
5. Each participant sends their signature share (r, sᵢ) to the coordinator.
6. When the coordinator has received 2t+1 signature shares, they calculate:
   s=interpolate(s₁, . . . , s₂ₜ₊₁),
   and output the signature as (r,s).
7. The coordinator verifies the signature using the standard ECDSA verification. If this fails, at least one of the shares must be incorrect, and the signature generation algorithm should be run again.

### 1.12 Addition of Secrets with Different Thresholds

In the case of addition of secrets of order t and t′, the addition of the two secrets requires max(t, t′)+1 number of shares to calculate it. The reason behind this is that the addition step of the shares of the shared secrets creates a share of a new polynomial. This new additive polynomial is equivalent to the result of the addition of the individual polynomials of the two shared secrets. Adding two polynomials is adding the corresponding coefficients at each order of x. Therefore, the order of the additive polynomial must be the same order as the highest order of the two polynomials. This can be generalised to the addition of more than two polynomials, where the order of the resulting polynomial is the same as the order of the highest order individual polynomial.

Once the addition of two secrets with different thresholds has been calculated, the security of the higher threshold secret is reduced. This is because if one now knows the result (a+b) with respective thresholds t, t′ and assume that t<t′, then one can calculate a with t shares, and then calculate (a+b)−a=b, and so the value b has been calculated with only t shares. This lower threshold is referred to below as the ‘implicated threshold’ of b.

### 1.13 Multiplication of Secrets with Different Thresholds

In the case of multiplication of two secrets with a threshold of t and t′, the calculation of the multiplication requires t+t′+1 shares. In this case, the multiplication of shares of two polynomials results in a share on a new polynomial. This new polynomial is the result of multiplying the two individual polynomials and so the order of the result is the addition of the order of the two individual polynomials.

Multiplication can also be generalised to any number of shared secrets, with the resulting threshold being the sum of the individual thresholds plus 1,Σ_{ρ}t_{ρ}+1, where ρ runs over the individual shared secrets.

Similar to addition, the multiplication of two secrets with different thresholds results in an implicated threshold of the higher threshold secret. As before, if ab is known where a has a threshold of t and b has a threshold of t′, and t<t′, then both a and b can be calculated with t shares. First, one can calculate a and using (ab)a⁻¹ find b with only t shares of a secret.

### 1.14 Combining the Addition and Multiplication of Shared Secrets in One Step

It is possible to generalise the above to calculate any combination of addition and multiplication in one step. Assume a group of N participants want to calculate the result ab+c, where a, b, c are shared secrets with thresholds (tₐ+1), (t_{b}+1), (t_{c}+1) respectively. There is a condition which is max(tₐ+t_{b}, t_{c})<N, that is, the number of participants of the scheme must be greater than the maximum between the order of the secret c and the order of the result of the multiplication of the secrets a and b.
1. Each participant i calculates their secret shares aᵢ=JVRSS(i), bᵢ=JVRSS(i), cᵢ=JVRSS(i) with thresholds (tₐ+1), (t_{b}+1), (t_{c}+1) respectively.
2. Each participant i calculates the share λᵢ=aᵢbᵢ+cᵢ.
3. Each participant i shares the result λᵢ with the other participants.
4. Each participant interpolates over max(tₐ+t_{b}, t_{c})+1 shares to find the result λ=int(λ₁, . . . , λᵢ, . . . )=ab+c.

This is done in the calculation of a shared signature according to some embodiments below. That is, there is an interpolation over sᵢ=k⁻¹(e+aᵢr). This is essentially the case above with aᵢbᵢ=kᵢ⁻¹aᵢr and cᵢ=kᵢ⁻¹e. In this case tₐ+t_{b}=2t and t_{c}=t, and interpolation is over max(tₐ+t_{b}, t_{c})+1=2t+1 shares.

### 1.15 HD Wallets

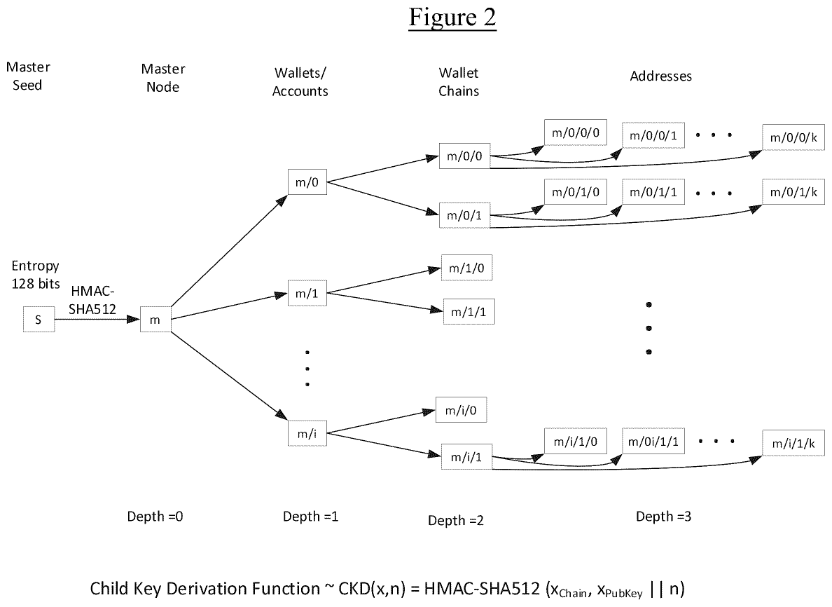

Hierarchical Deterministic wallets, of which a Bitcoin Improvement Proposal 32 (BIP32) wallet is a particular type, are deterministic wallets where many keys can be derived from a single input. The input is some random entropy called the seed, from which a master key is derived. The master key is then used to derive multiple child keys, as shown in FIG. 2.

In BIP32 the master private key is the left 32 bytes of the result of the HMAC-SHA512 of the seed, or explicitly, it is

$${sk}_{master} = HMAC - SHA {512}_{L} ( ‘ Bitcoin Seed ’ , seed ) ,$$

and the chain code is

$${c}_{master} = HMAC - SHA {512}_{R} ( {}^{′} Bitcoin {Seed}^{′} , seed ) ,$$

and all child keys can be then derived from these, where

$$HMAC - SHA 512 ( c , K ) = SHA 512 ( c ⊕ opad ‖ SHA 512 ( ( c ⊕ ipad ) ‖ K ) )$$

is the HMAC using the SHA512 hash function. In the equation above, opad is the block-sized outer padding, and ipad is the block-sized inner padding.

A HMAC requires two inputs, i.e. c and K. For simplicity and so that users are only required to remember or store a single seed, the BIP32 protocol sets the first input as the string ‘Bitcoin Seed’, i.e. c=‘ Bitcoin Seed’ It will be appreciated that this is one example protocol for generating a HD wallet and that different protocols may require different inputs, e.g. two randomly generated seeds. In other words, the use of the string ‘Bitcoin Seed’ is not a necessary requirement for generating a HD wallet.

The equation for calculating a hardened child private key sk_{child} from a parent private key skₚₐᵣₑₙₜ is

$${sk}_{child} = {sk}_{parent} + HMAC - SHA {512}_{L} ( {c}_{parent} , {sk}_{parent} ‖ index ) ,$$

where cₚₐᵣₑₙₜ is the parent chain code, 0≤ index <2³¹ is the child index, and HMAC-SHA512_{L} is the left 32 bytes of the result of the HMAC function calculated with the SHA-512 hash function. The corresponding equation for the child public key is derived by simply point multiplying this equation by the base point G.

The equation for calculating a non-hardened child private key sk_{child} from a parent public key pkₚₐᵣₑₙₜ and parent private key skₚₐᵣₑₙₜ is

$${sk}_{child} = {sk}_{parent} + HMAC - SHA {512}_{L} ( {c}_{parent} , {pk}_{parent} ‖ index ) ,$$

where cₚₐᵣₑₙₜ is the parent chain code, 2³¹≤ index <2³² is the child index, and HMAC-SHA512 is the HMAC function calculated with the SHA-512 hash function. This second type of child key allows for child public keys to be derived by anyone with knowledge of the parent public key and chain code using the equation

$${pk}_{child} = {pk}_{parent} + HMAC - SHA {512}_{L} ( {c}_{parent} , {pk}_{parent} ‖ index ) \cdot G .$$

This can be used by external parties to derive various payment addresses as required, avoiding key reuse, whilst reducing rounds of communication and storage.

In general, an HD wallet should generate some hierarchical tree-like structure of private-public key pairs. This provides a high number of key pairs that can all be regenerated from one seed.

### 2. Generating Private Key Shares

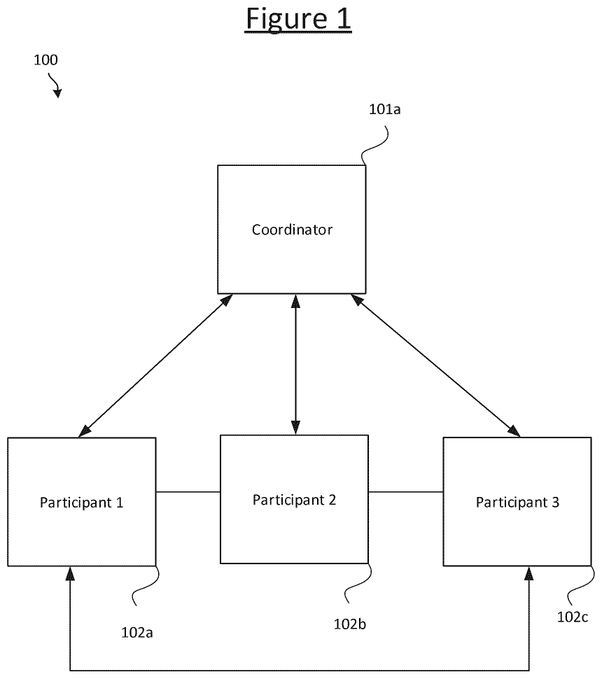

FIG. 1 illustrates an example system 100 for implementing the described embodiments. As shown, the system 100 comprises a coordinator (or coordinating party) 101 and a plurality of participants 102. Only three participants 102 are shown in FIG. 1, but it will be appreciated that in general the system may comprise any number of participants. The coordinator 101 and each of the participants 102 operates respective computing equipment. In some examples the coordinator 101 may also take the role of a participant 102.

Each respective computing equipment comprises respective processing apparatus comprising one or more processors, e.g. one or more central processing units (CPUs), accelerator processors such a graphics processing units (GPUs), other application specific processors, and/or field programmable gate arrays (FPGAs). The respective computing equipment may also comprise memory, i.e. computer-readable storage in the form of a non-transitory computer-readable medium or media. The memory may comprise one or more memory units employing one or more memory media, e.g. a magnetic medium such as a hard disk; an electronic medium such as a solid-state drive (SSD), flash memory or EEPROM; and/or an optical medium such as an optical disk drive. The respective computing equipment may comprise at least one user terminal, e.g. a desktop or laptop computer, a tablet, a smartphone, or a wearable device such as a smartwatch. Alternatively or additionally, the respective computing equipment may comprise one or more other networked resources, such as cloud computing resources accessed via the user terminal (the cloud computing resources comprising resources of one or more physical server devices implemented at one or more sites). It will be appreciated that any act described as being performed by the coordinator 101 or a participant 102 may be performed by the respective computing apparatus operated by coordinator 101 or a participant 102, respectively.

The coordinator 101 is configured to transmit data to each of the participants 102 over the internet using a LAN or WAN connection, or via alternative wired or wireless communication means. Similarly, each participant 102 may be configured to transmit data to one, some or all of the other participants 102 over the internet using a LAN or WAN connection, or via alternative wired or wireless communication means. Unless the context requires otherwise, reference to a party (coordinator 101 or participant 102) transmitting data may be understood as transmitting data to another party 101, 102 individually, e.g. via a secure communication channel between the parties, or broadcasting data to the parties as a whole, e.g. via email or other means. Again, unless the context requires otherwise, party 101, 102 may transmit data in raw form, or in encrypted form. For instance, the data may be encrypted using a public key of a recipient participant before being sent to that recipient participant.

Embodiments will primarily be described from the perspective of the first participant 102a. However it will be appreciated that in general steps of the described method may similarly be performed by other participants, e.g. the second participant 102b or third participant 102c. It will also be appreciated that the terms “first”, “second”, “third” and so on are used herein merely as distinguishing labels and do not necessarily imply an order, unless the particular context in which the terms are used requires otherwise.

The present disclosure describes techniques that enable each participant 102 of a group of participants 102 to generate respective shares of one or more shared private keys that are each linked to a shared master private key. That is, each participant 102 can obtain a share of a master private key, and then use the master private key share to derive shares of additional private keys (generally referred to as child private keys), e.g. to generate a shared wallet. Here, a wallet is a term for a collection of keys, e.g. stored in memory of a given participant 102.

To begin with, the coordinator 101 generates a master private key by hashing at least a seed with a hash function. The seed may be a number or a string. In some examples, additional data (i.e. a second seed), such as a number or a string, is hashed together with the (first) seed. This increases the entropy of the master private key. The first and/or second seeds may be pseudo-randomly generated by the coordinator 101. Any hash function may be used, e.g. SHA256, SHA512, etc. In some examples a hash function that performs more than one hashing operation could be used, such as a double-hash, e.g. SHA256 followed by SHA256. Preferably the hash function is a hash-based message authentication code (HMAC) function. A HMAC function requires two inputs—the first and second seed mentioned above.

The master private key comprises a first portion (i.e. part or component) of the output of the hash function. The output of the hash function is referred to as a hash digest. The master private key may be the first half of the hash digest. For instance, the hash digest produced by the SHA256 hash function is 256 bits, in which case the master private key may be the leftmost 128 bits of the hash digest. The hash digest produced by the HMAC function is 512 bits, in which case the master private key may be the leftmost 256 bits of the hash digest.

In these examples, the first component may be the entire output of the HMAC function, or a part of the output, e.g. the left 256 bytes.

A second portion of the hash digest is used by the coordinator 101 as a master chain code for the master private key. For instance, the master chain code may be the leftmost 128 bits or 256 bits if the SHA256 function is used or the HMAC function is used, respectively. The purpose of the master chain code is to add more entropy into the derivation of child keys. The coordinator 101 also generates a master public key based on the master private key. The master public key may be generated based on elliptic curve point multiplication of the master private key with an elliptic curve generator point.

The master chain code and the master public key are made available to the participants 102. The coordinator 101 may send the master chain code and the master public key directly to each participant 102, or to one or more participants 102 who then forward the data onto the remaining participants.

The master private key is not shared with the participants 102. Instead, the coordinator 101 uses a secret sharing scheme to split the master private key into shares (“master private key shares” and distribute a respective master private key share to each participant 102. For instance, a first master private key share is sent to the first participant 102a, a second master private key share is sent to the second participant 102b, and a third master private key share is sent to the third participant 102c. Each participant 102 receives only a single master private key share. Once the master private key shares have been distributed to the participants 102, the coordinator 101 may delete the master private key from memory. This increases the security of the master private key as it no longer available in the clear for an attacker to steal.

The coordinator 101 may use Shamir's secret sharing scheme (SSSS) to split the master private key into shares and distribute those shares to the participants 102. The skilled person will be familiar with SSSS. Details are given below.

The coordinator 101 may also be a participant 102 of the scheme. That is, one of the master private key shares may be kept by the coordinator 101 for use in generating child private key shares. In other words, the coordinator 101 may deal a share of the master private key to itself.

As mentioned, each participant 102 obtains, from the coordinator 101, a respective master private key share, the master chain code, and the master public key. Each participant 102 then generates one or more child private key shares. For instance, the first participant 102a may generate a first share of a first child private key, the second participant 102b may generate a second share of the first child private key, and the third participant 102c may generate a third share of the first child private key. Similarly, the first participant 102a may generate a first share of a second, different child private key, the second participant 102b may generate a second share of the second child private key, and the third participant 102c may generate a third share of the second child private key. The participant 102 may generate shares in a plurality of child private keys.

Each child private key share is generated in a similar manner. Each child private key share is based on a master private key share. Each child private key share is also based on a first portion (i.e. component) of the output of inputting the master chain code, the master public key and a respective key index into a hash function. The hash function is preferably the same hash function that is used by the coordinator 101 to generate the master private key. The first portion may be a first half of the hash digest, e.g. the leftmost 256 bits of the hash digest produced when the hash function is the HMAC function.

For example, the first participant 102a generates a first share of a first child private key based on a first master private key share and a portion of a hash of the master chain code, the master public key and a first key index. Similarly, the second participant 102b generates a second share of the first child private key based on a second master private key share and a portion of a hash of the master chain code, the master public key and the first key index.

The first participant 102a may generate a first share of a second, different child private key based on the first master private key share and a portion of a hash of the master chain code, the master public key and a second, different key index. Similarly, the second participant 102b may generate a second share of the second child private key based on the second master private key share and a portion of a hash of the master chain code, the master public key and the second key index.

In this way, the participant 102 generate shares of the same child private keys.

The participants 102 may generate public keys for the child private keys, i.e. child public keys corresponding to the child private keys. The participants 102 do not have access to the complete child private key can so cannot simply generate the child public key using the elliptic curve generator point. Instead, the child public key is generated based on the master public key and a public key corresponding to the first portion of the hash digest that was used to generate the share of the child private key share. That is, the child public key is based on the master public key and the result of applying an elliptic curve generator point to the first portion of the hash of the master chain code, the master public key and the respective key index.

The participants 102 may also generate chain codes for the child private keys. The chain code for a given child private key is generated based on a second portion of the hash of the master chain code, the master public key and the respective key index. For instance, the second portion of the hash may be the second half (e.g. rightmost 256 bits) of the hash digest.

The chain codes for a given child private key is used to generate shares of the children of that child private key, i.e. grandchildren of the master private key. Shares of a grandchild private key are generated in a similar way to the share of a child private key. Each grandchild private key share is based on a child private key share. Each grandchild private key share is also based on a first portion (i.e. component) of the output of inputting the child key chain code, the child public key and a respective key index into a hash function. Here, the “child key chain code” is the chain code of the child private key. The hash function is preferably the same hash function that is used by the participants 102 to generate the child private key shares. The first portion may be a first half of the hash digest, e.g. the leftmost 256 bits of the hash digest produced when the hash function is the HMAC function.

For example, the first participant 102a may generate a first share of a first grandchild private key based on a first share of a first child private key and a portion of a hash of a first child key chain code, the first child public key and a first key index. Similarly, the second participant 102b may generate a second share of the first grandchild private key based on a second share of the first child private key and a portion of a hash of the first child key chain code, the first child public key and the first key index.

The first participant 102a may generate a first share of a second, different grandchild private key based on the first share of a first child private key and a portion of a hash of the first child key chain code, the first child public key and a second, different key index. Similarly, the second participant 102b may generate a second share of the second grandchild private key based on the second share of the first child private key and a portion of a hash of the first child key chain code, the first child public key and the second key index.

The participant 102 may also generate shares of the child keys of one or more different child private keys.

The private key shares may be used as part of a signature scheme to sign a message, and/or as part of an encryption scheme to encrypt a message, or for a different purpose. For instance, when used as part of a signature scheme, the first participant 102a may use a first private key share to generate a first signature share for a message. The second participant 102b may similarly generate a second signature share for the message, and similarly the third participant 102c may generate a third signature share. The first, second and third signature shares may be used to generate a full signature. The signature scheme may be a threshold signature scheme in which case only a threshold number of signature shares may be required to generate a signature.

The concept of HD key structures (or HD wallets) was introduced above. Each participant 102 may generate a HD key structure of private key shares, where each private key share is ultimately derivable from the master key share distributed to that participant 102. The HD key structure may comprise multiple levels of child private key shares. Some private key shares may be both a parent to a respective child private key share, and a child of a respective parent private key share. The HD key structure may resemble that shown in FIG. 2. As shown in FIG. 2, each private key in HD key structure has a parent private key.

The parent of the private keys in a first level in the HD key structure may be the master private key, where the master private key is at the zeroth level. The message may comprise at least part of a blockchain transaction, as discussed further below.

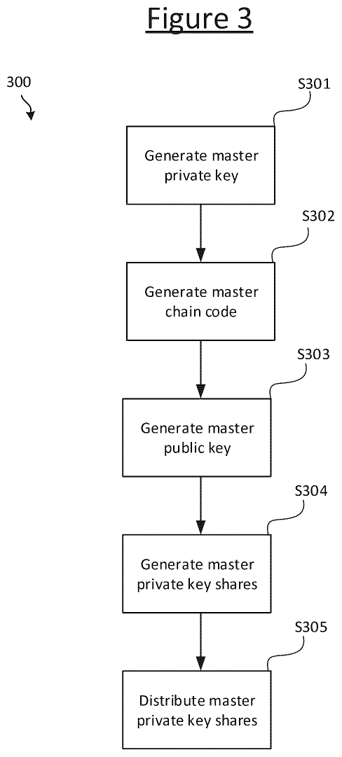

FIG. 3 shows an example method 300 according to some embodiments of the present disclosure. At step S301, the coordinator 101 generates a master private key based on a seed. At step S302, the coordinator 101 generates a master chain code. At step S303 the coordinator generates a master public key. At step S304, the coordinator generates master private key shares, and at step S305 the coordinator distributes those private key shares to the participants 102.

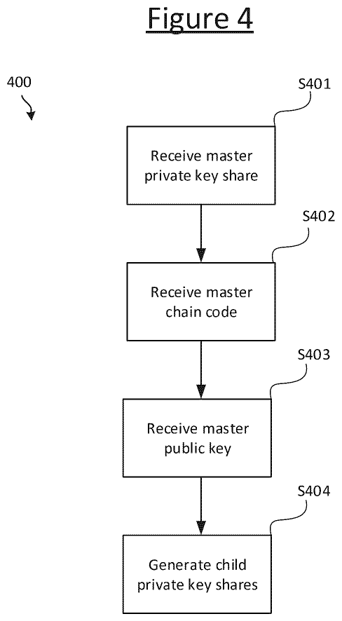

FIG. 4 shows another example method 400 according to some embodiments of the present disclosure. At step S401, each participant 102 receives a master private key share.

At steps S402 and S403, each participant receives a master chain code and master public key, respectively. At step S404, each participant 102 generates one or more child private key shares. Each participant 102 may also generate one or more grandchild private key shares.

Each participant 102 may generates a HD key structure based on their respective master private key share.

An example implementation of the described embodiments is now provided. As mentioned, one difficulty of deriving a shared wallet exactly as described in BIP32 is due to the requirement of calculating the hash of a shared secret (i.e. the master private key). It is difficulty and therefore impractical to calculate the hash function of a shared secret without calculating that secret explicitly. The present disclosure enables a shared wallet to be created that follows BIP32 by using a dealer (i.e. the coordinator 101) initially. This allows for a shared wallet containing non-hardened keys as described in BIP32.

The method begins by assuming that there is a trusted party 101 that acts as a dealer in the scheme of N participants 102 and each participant has agreed a participant index i. This trusted party 101 randomly generates a master seed seed. They derive the master private key and chain code as described in BIP32 using

$${sk}_{master} = HMAC - SHA {512}_{L} ( {}^{′} Bitcoin {Seed}^{′} , seed ) ,$$

to derive the master private key and the chain code is

$${c}_{master} = HMAC - SHA {512}_{R} ( {}^{′} Bitcoin {Seed}^{′} , seed ) ,$$

The trusted party 101 then uses Shamir's secret sharing scheme to share the secret key skₘₐₛₜₑᵣ among the participants. That is, they generate t random numbers aⱼ for j=1, . . . , t. The dealer 101 defines the polynomial

$${f}_{master} ( x ) = {sk}_{master} + {a}_{1} x + … + {a}_{t - 1} {x}^{t - 1} + {a}_{t} {x}^{t} ,$$

where t+1 is the threshold of the shared secret.

The dealer 101 then derives the values aᵢ₋ₘₐₛₜₑᵣ=fₘₐₛₜₑᵣ(i) for all i=1, . . . , N and communicates aᵢ₋ₘₐₛₜₑᵣ to participant i using a secure communication channel with that participant.

The dealer also calculates the corresponding public key pkₘₐₛₜₑᵣ=skₘₐₛₜₑᵣ·G and shares the public key pkₘₐₛₜₑᵣ with all participants with the master chain code cₘₐₛₜₑᵣ. The dealer 101 may now delete the private key skₘₐₛₜₑᵣ. If the shared private key skₘₐₛₜₑᵣ needs to be recovered, one may recover it using Lagrange interpolation or reissuing shares (as described in WO2021254702).

In order to derive any non-hardened child keys, each participant 102 calculates their child key share for a given index 2³¹≤ index ≤2³² using

$${a}_{i - child} = {a}_{i - parent} + HMAC - SHA {512}_{L} ( {c}_{parent} , {pk}_{parent} ‖ index ) ,$$

and the corresponding public key

$${pk}_{child} = {pk}_{parent} + HMAC - SHA {512}_{L} ( {c}_{parent} , {pk}_{parent} ‖ index ) \cdot G .$$

The participants 102 may also calculate the child chain code

$${c}_{child} = HMAC - SHA {512}_{R} ( {c}_{parent} , {pk}_{parent} ‖ index )$$

for use in the derivation of any grandchild keys.

The participants 102 in the scheme may use a_{i-child} in the same way as a private key share aᵢ in any threshold signature scheme or other threshold technique.

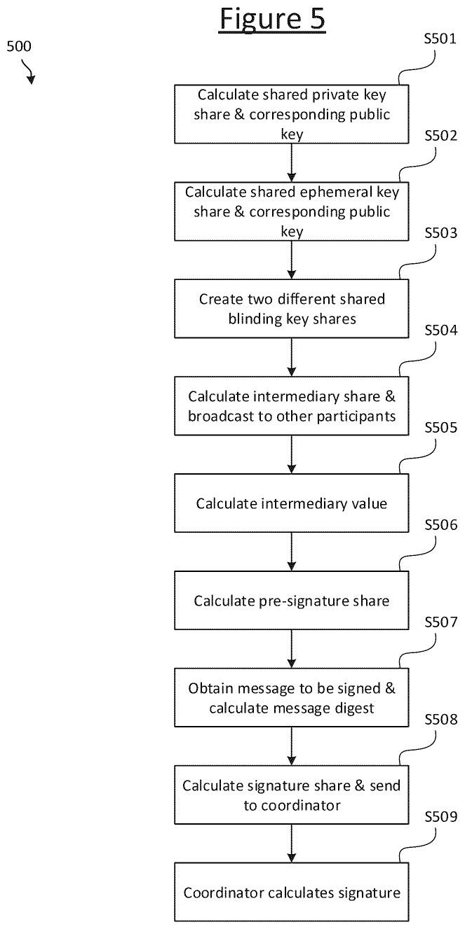

FIG. 5 illustrates an example method 500 for generating a signature on a message according to some embodiments of the present disclosure. Steps S501 to S508 are performed by each of a threshold number of participants 102 in this example (including the first participant 102a). Step S509 is performed by a coordinator 101, who may also may one of the participants performing steps S501 to S405. It will be appreciated that some of the steps may be omitted or be performed in a different order.

The example method 500 enables the creation of a shared secret of threshold (t+1) in a group of N≥2t+1 participants, where the signing threshold is also (t+1).

Set-up:

In step S501, each participant 102 calculates a child private key share a_{i-child} and a corresponding public key. The generation of the child private key share a_{i-child} has been described above. At this point, each participant i has a secret child key share and public key (a_{i-child}, P), where P is notation for the public key corresponding to the shared private key, i.e. a_{child}·G. The shared private key has a threshold of (t+1).

Pre-calculation:

In step S502, each participant 102 calculates a shared ephemeral key share and a corresponding public key. For instance, each participant 102 may calculate a shared ephemeral key using JVRSS and the calculation of the public key given in the preliminaries. Each participant 102 may then calculate an inverse share based on the ephemeral private key. This results in each participant having an inverse share (k 1, r), with a threshold of (t+1).

In step S503, each participant 102 creates two different shared blinding key shares. For instance, each participant 102 may create two shared secrets so that participant i has shares aᵢ=JVRSS(i) and βᵢ=JVRSS(i), each shared secret having a threshold (t+1). Note that in some examples, not all of the shared secrets need to have the same threshold.

In step S504, each participant 102 calculates an intermediary share and broadcasts their intermediary share to the other participants. For instance, each participant i may calculate the intermediary share λᵢ=kᵢ⁻¹a_{i-child}+βᵢ. This value has a threshold of (2t+1).

In step S505, each participant 102 calculates an intermediary value based on at least the intermediary shares. For instance, each participant 102 may calculate the intermediary value using interpolation over (2t+1) shares λ=interpolate(λ₁, . . . , λ₂ₜ₊₁)=k⁻¹a+β.

In step S506, each participant 102 calculates a pre-signature share. For instance, each participant i may calculate their pre-signature share σᵢ=λ−βᵢ=(k⁻¹a+β)−βᵢ. Each participant 102 may store (r, kᵢ⁻¹, σᵢ), and the private key share and corresponding public key (a_{i-child}, P).

Note that since a different ephemeral key is used for each signature, multiple ephemeral keys can be set up at one time, that is, steps S502 to S506 can be repeated to create multiple ephemeral keys during pre-calculation and stored for later use. These can be executed at the same time so that there are no additional rounds of communication. Note that preferably, a different value of α and β should be used for each signature.

### Signature Generation:

In order to sign a message msg, at least (t+1) participants must perform steps S507 and S508.

In step S507, at least the threshold number of participants 102 obtain a message to be signed and calculate a message digest. For instance, a coordinator 101 may send a request to (t+1) participants to create a signature share on the message msg. Each participant i may calculate the message digest e=hash(msg). In some examples, this hash function is the double SHA-256 hash function. Alternative hash functions may be used.

In step S508, at least the threshold number of participants 102 calculate a signature share and send it to the coordinator 101. For instance, each participant i may calculate their signature share sᵢ=kᵢ⁻¹e+rσᵢ, and then send their signature share (r, sᵢ) to the coordinator. Note that the value r may not be sent by all participants.

In step S509, the coordinator 101 calculates the signature. For instance, the coordinator 101 may calculate s=interpolate(s₁, . . . , sₜ₊₁)=k⁻¹(e+ar), and finally the signature (r,s).

There are several alternatives for pre-calculating the message independent component of the signature share. These can broadly be split into two sets of variations: when to include r in the calculation, and when to include (ka)⁻¹. These can be selected independent of each other and so there are eight variations to the above method 500.

One modification is to store (r, kᵢ⁻¹, rσᵢ) during step S506, meaning that r is included in the pre-signature share. Another modification is that the multiplication with r can also come earlier during the calculation of the intermediary shares. By defining instead λᵢ=rkᵢ⁻¹a_{i-child}+βᵢ in step S504, then in step S506, σᵢ=λ−βᵢ=(rk⁻¹a+β)−βᵢ and the calculation of signature shares is sᵢ=kᵢ⁻¹e+σᵢ.

Another modification is to instead calculate λᵢ=aᵢa_{i-child}+βᵢ such that λ=(ka)⁻¹(aa+β), and σᵢ=λ−(ka)⁻¹βᵢ. The two variations of including r at alternative points can be done in combination with this. Each participant has knowledge of ka as it is calculated in step S502 of the pre-calculation. Additionally, all participants 102 broadcast their λᵢ share. So each participant 102 has knowledge of (at least) 2t+1 shares and the value ka. They can then calculate

$$λ = {( k α )}^{- 1} \times interpolate ( {λ}_{1} , ... . , {λ}_{2 t + 1} )$$

Another modification is to instead calculate the intermediary value as λ=(aa+β) and the pre-signature share as σᵢ=λ−βᵢ. Finally, the signature share would then be sᵢ=kᵢ⁻¹e+r(ka)⁻¹σᵢ. The two variations of when to include r in the calculation can also be done in combination with this. Each participant 102 has knowledge of ka from the calculation of kᵢ⁻¹. They can then calculate (ka)⁻¹ mod n with this, and then include it in the calculation of sᵢ.

In summary, each participant 102 may generate four secret shares: a_{i-child}, kᵢ, aᵢ, βᵢ. Two products need to be calculated in the example method 500: ka which is then used to calculate (ka)⁻¹a_{i-child}=kᵢ⁻¹ (interpolation over these shares gives k⁻¹ as the a's will cancel, and k⁻¹a for use in the signature, which uses the first product, and so if the shares are expanded, the calculated gives kᵢ⁻¹a_{i-child}=(ka)⁻¹aᵢa_{i-child}. Any calculations with the kᵢ⁻¹ share, which is made of ka and a_{i-child}, can be done by doing the calculation just with aᵢ itself first, and then multiplying by (ka)⁻¹ where necessary.

One version of the above scheme can be summarised by saying that a signature is calculated using shares that are composed of a message independent component (MIC) and a message dependent component (MDC), where the MIC may be based on the pre-signature share oi and the MDC is based on the message e.

An equivalent scheme comprises calculating the MIC as above, and then incorporating this in the signature along with the signature shares, e.g. after interpolation of the signature shares which are made of just an MDC. Explicitly, the scheme may be same up to step S506 of the pre-calculation, where the intermediary shares include the r value, λᵢ=kᵢ⁻¹a_{i-child} r+βᵢ such that after interpolation this is λ=k⁻¹ar+β.

At this stage, the participants have knowledge of (r, kᵢ⁻¹λ, βᵢ) and store this along with the private key share and corresponding public key (a_{i-child},P).

Then in order to generate their signature share on a given message m which is hashed to create the message digest e=hash(m), the participants calculate

$${s}_{i} = {k}_{i}^{- 1} e - {β}_{i} ,$$

and send this to a coordinator. The coordinator then calculates

$$s = interpolate ( {s}_{1} , ... , {s}_{t + 1} ) + λ , = {k}^{- 1} e + {k}^{- 1} ar ,$$

resulting in the expected signature share since the β terms cancel. Similar variations of this protocol can be made as above describing when the (ka)⁻¹ and r is included in the calculation.

The following variations for calculating the message-independent component may be implemented:
i) Calculate λ=k⁻¹a+β, then the signature shares are now sᵢ=kᵢ⁻¹e−rβᵢ, and the signature is generated as s=int(s₁, . . . , sₜ₊₁)+rλ.
ii) Calculate λ=aar+β, then the signature shares are now sᵢ=aᵢe−βᵢ, and the signature is generated as s=(ka)⁻¹(int(sᵢ, . . . , sₜ₊₁)+λ).
iii) Calculate λ=aa+β, then the signature shares are now sᵢ=kᵢ⁻¹e−rβᵢ, and the signature is generated as s=(ka)⁻¹(int(sᵢ, . . . , sₜ₊₁)+rλ).
iv) Calculate λ=aar+β, then the signature shares are now sᵢ=kᵢ⁻¹e−(ka)⁻¹βᵢ, and the signature is generated as s=(int(s₁, . . . , sₜ₊₁)+(ka)⁻¹λ).
v) Calculate λ=aa+β, then the signature shares are now sᵢ=kᵢ⁻¹e−r(ka)⁻¹βᵢ, and the signature is generated as s=(int(s₁, . . . , sₜ₊₁)+r(ka)⁻¹l).

Note that the thresholds of the secrets may be different. That is the threshold of a_{child}, k, α, β themselves do not necessarily need to be the same to execute the signature generation scheme. For example, if there is a group of six and three are needed to create the signature and/or private key, they could technically do the calculation with the threshold of the k being four and the thresholds of the other shared secrets being three, and they will still have a threshold-optimal scheme.

Note that the present invention may be applied to any threshold signature scheme (whether optimal or non-optimal) and is not limited to the particular scheme described above.

In general, embodiments of the present disclosure may be used to generate a signature on any message. As a particular example use case, the message may be part or all of a blockchain transaction. That is, the signature may be used to sign one or more inputs and/or one or more outputs of a blockchain transaction. For instance, the generated signature may be used, at least in part, to unlock an output of a blockchain transaction. As a particular example, the output of a previous transaction may be a pay-to-public-key-hash (P2PKH) output which is locked to a hash of a public key. In order to be unlocked, an input of a later transaction that references the P2PKH output needs to include the (unhashed) public key and a signature generated based on the private key corresponding to the public key.

Represented in script, the “locking script” and “unlocking script” may take the following forms:

$$Locking script = OP\_DUP OP\_HASH160 \text{} < Public KeyHash > OP\_EQUAL OP\_CHECKSIG$$

$$Unlocking script = < Signature > < Public Key >$$

Referring to the above described embodiments, the <Public Key> may be equated to P=a_{child}·G, and the <Signature> comprises the threshold signature s, where the previous transaction is the message to be signed. Note that as stated above, ECDSA signatures are in the form (r,s).

Note that the described signature generation method is not limited to any particular use case and may in general be used for generating a signature based on any message. Signing all or part of a blockchain transaction is just one illustrative example. The described method may be used to sign and/or authorise, for instance, a legal document (e.g. a will, deed or other contract), correspondence between one or more parties, digital certificates (e.g. issued by a certificate authority), medical prescriptions, a bank transfer or a financial instrument, a mortgage or loan applications, etc.

As a particular example, the group of participants (say five participants in total) may form the board of a company. Voting matters of the company may require a majority of the board (i.e. at least three participants) to agree on the particular vote. The board may use the described signature generation method to prove that at least three board members agreed to vote in favour of a particular outcome. In this example, the threshold of the signature generation scheme is three. That is, at least three of the board members must provide a respective signature share in order for the co-ordinator to successfully generate a signature. If a signature is generated successfully, at least the threshold number (i.e. three) of board members must have agreed to vote in favour of that outcome. Thus the successful generation of a signature acts as a record of the vote and proves that a majority of the board voted in a particular way.

Another use case for the present invention lays in the field of digital certificates, e.g. digital certificate issued by the X.509 standard. A digital certificate contains a signature that signs over some data. The data can in general be any data, but one particular example of data included in a digital certificate is a public key. A public key in a digital certificate is often referred to as a “certified public key”. The issuer of the digital certificate (a “certificate authority”) may perform one or more checks on the owner of the public key (e.g. know-your-customer checks), and if the checks are successful, the certificate authority issues a digital certificate that includes the certified public key. A user can use a certified public key to prove they are who they say they are, e.g. by signing a message with a private key corresponding to the certified public key. One particular use for certificate authorities is to sign certificates used in HTTPS for secure browsing on the internet. Another common use is in issuing identity cards by national governments for use in electronically signing documents. The certificate authority signs the public key (or any other data to be attested to) using a private key.

As stated above, embodiments of the present invention may involve encrypting a message with a public key corresponding to a private key share, and similarly decrypting the message with a private key share. In that case, the first participant 102a may decrypt the message that has been encrypted by a different party. As another option, a message may be encrypted with a public key corresponding to a full private key, e.g. a full child key. In that case, at least a threshold number of participants may make their respective shares of the child private key available in order to decrypt the message. The message that is encrypted may comprise some or all of a blockchain transaction, e.g. encrypted data may be included in a transaction to be recorded on the blockchain.

### 3. Conclusion

Other variants or use cases of the disclosed techniques may become apparent to the person skilled in the art once given the disclosure herein. The scope of the disclosure is not limited by the described embodiments but only by the accompanying claims.

It will be appreciated that the above embodiments have been described by way of example only. More generally there may be provided a method, apparatus or program in accordance with any one or more of the following Statements.

Statement 1. A computer-implemented method of generating shares of child private keys, and wherein the method is performed by a first participant of the group and comprises:
receiving, from a coordinator, a first share of a master private key, wherein the master private key is generated based on a first portion of a hash of a seed value;
receiving, from a coordinator, a master chain code for the master private key, wherein the master chain code is generated based on a second portion of the hash of the seed value;
receiving, from a coordinator, a master public key corresponding to the master private key;
generating one or more first shares of one or more respective child private keys, wherein each first share of the respective child private key is generated based on the first share of the master private key, and a first portion of a hash of i) the master chain code, ii) the master public key and iii) a respective key index.

Statement 2. The method of statement 1, comprising:
for each respective child private key, generating a corresponding respective child public key, wherein each respective child public key is generated based on the master public key, and a public key corresponding to the first portion of a hash of i) the master chain code, ii) the master public key and iii) the respective key index.

Statement 3. The method of statement 1 or statement 2, comprising:
for each respective child private key, generating a respective chain code, wherein the respective chain code is generated based on a second portion of a hash of the first share of the master private key, the master chain code, the master public key and the respective key index.

Statement 4. The method of statement 3, comprising:
for at least one respective child private key, generating one or more first shares of one or more respective grandchild private keys, wherein each first share of the respective grandchild private key is generated based on the first share of the at least one respective child private key, and a first portion of a hash of i) the respective chain code for the at least one child private key, ii) the child public key corresponding to the at least one child private key, and iii) a respective key index.

Statement 5. The method of any preceding, wherein the hash the first share of the master private key, the master chain code, the master public key and a respective key index is a hash-based message authentication code, HMAC, of the first share of the master private key, the master chain code, the master public key and a respective key index.

Statement 6. The method of any preceding statement, comprising performing a signing phase of a threshold signature scheme, said performing comprising:
obtaining a message;
generating a first signature share based on the message and a) one of the first child private key shares, b) one of the first grandchild private key shares, or c) a first private key share derived from a) or b); and
sending the first signature share to the coordinator.

Statement 7. The method of statement 6, wherein the threshold signature scheme is a threshold-optimal signature scheme.

Statement 8. The method of statement 6 or statement 7, wherein the message comprises at least part of a blockchain transaction.

Statement 9. A computer-implemented method for enabling participants of a group to generate shares of child private keys, and wherein the method is performed by a coordinator and comprises:
generating a master private key based on a first portion of a hash of a seed value;
generating a master chain code for the master private key, wherein the master chain code is generated based on a second portion of the hash of the seed value;
generating a master public corresponding to the master private key;
using a secret sharing scheme to make a respective share of the master private key available to each respective participant; and
making the master chain code available to each participant,
wherein each participant is configured to generate a respective share of a first child private key based on the respective share of the master private key, and a first portion of a hash of i) the master chain code, ii) the master public key and iii) a first key index.

Statement 10. The method of statement 9, wherein the secret sharing scheme is Shamir's secret sharing scheme.

Statement 11. The method of statement 9 or statement 10, wherein the hash of the seed value is a hash-based message authentication code, HMAC, of the seed value.

Statement 12. The method of any of statements 9 to 11, comprising deleting the master private key from memory.

Statement 13. The method of any of statements 9 to 12, wherein the coordinator is one of participants.

Statement 14. Computer equipment comprising:
memory comprising one or more memory units; and
processing apparatus comprising one or more processing units, wherein the memory stores code arranged to run on the processing apparatus, the code being configured so as when on the processing apparatus to perform the method of any of statements 1 to 13.

Statement 15. A computer program embodied on computer-readable storage and configured so as, when run on one or more processors, to perform the method of any of statements 1 to 13.

According to another aspect disclosed herein, there may be provided a method comprising the actions of the coordinator and at least one (e.g. each) participant.

According to another aspect disclosed herein, there may be provided a system comprising the computer equipment of the coordinator and at least one (e.g. each) participant.

1. A computer-implemented method of generating shares of child private keys, and wherein the method is performed by a first participant of the group and comprises:
receiving, from a coordinator, a first share of a master private key, wherein the master private key is generated based on a first portion of a hash of a seed value;
receiving, from a coordinator, a master chain code for the master private key, wherein the master chain code is generated based on a second portion of the hash of the seed value;
receiving, from a coordinator, a master public key corresponding to the master private key;
generating one or more first shares of one or more respective child private keys, wherein each first share of the respective child private key is generated based on the first share of the master private key, and a first portion of a hash of i) the master chain code, ii) the master public key and iii) a respective key index.

2. The method of claim 1, comprising:
for each respective child private key, generating a corresponding respective child public key, wherein each respective child public key is generated based on the master public key, and a public key corresponding to the first portion of a hash of i) the master chain code, ii) the master public key and iii) the respective key index.

3. The method of claim 1, comprising:
for each respective child private key, generating a respective chain code, wherein the respective chain code is generated based on a second portion of a hash of the first share of the master private key, the master chain code, the master public key and the respective key index.

4. The method of claim 3, comprising:
for at least one respective child private key, generating one or more first shares of one or more respective grandchild private keys, wherein each first share of the respective grandchild private key is generated based on the first share of the at least one respective child private key, and a first portion of a hash of i) the respective chain code for the at least one child private key, ii) the child public key corresponding to the at least one child private key, and iii) a respective key index.

5. The method of claim 1, wherein the hash the first share of the master private key, the master chain code, the master public key and a respective key index is a hash-based message authentication code, HMAC, of the first share of the master private key, the master chain code, the master public key and a respective key index.

6. The method of claim 1, comprising performing a signing phase of a threshold signature scheme, said performing comprising:
obtaining a message;
generating a first signature share based on the message and a) one of the first child private key shares, b) one of a first grandchild private key shares, or c) a first private key share derived from a) or b); and
sending the first signature share to the coordinator.

7. The method of claim 6, wherein the threshold signature scheme is a threshold-optimal signature scheme.

8. The method of claim 6, wherein the message comprises at least part of a blockchain transaction.

9. A computer-implemented method for enabling participants of a group to generate shares of child private keys, and wherein the method is performed by a coordinator and comprises:
generating a master private key based on a first portion of a hash of a seed value;
generating a master chain code for the master private key, wherein the master chain code is generated based on a second portion of the hash of the seed value;
generating a master public corresponding to the master private key;
using a secret sharing scheme to make a respective share of the master private key available to each respective participant; and
making the master chain code available to each participant,
wherein each participant is configured to generate a respective share of a first child private key based on the respective share of the master private key, and a first portion of a hash of i) the master chain code, ii) the master public key and iii) a first key index.

10. The method of claim 9, wherein the secret sharing scheme is Shamir's secret sharing scheme.

11. The method of claim 9, wherein the hash of the seed value is a hash-based message authentication code, HMAC, of the seed value.

12. The method of claim 9, comprising deleting the master private key from memory.

13. The method of claim 9, wherein the coordinator is one of participants.

14. Computer equipment, comprising:
memory comprising one or more memory units; and
processing apparatus comprising one or more processing units, wherein the memory stores code arranged to run on the processing apparatus, the code being configured so as when run on the processing apparatus, the processing apparatus performs a method of enabling participants of a group to generate shares of child private keys, and wherein the method is performed by a coordinator and comprises:
generating a master private key based on a first portion of a hash of a seed value;
generating a master chain code for the master private key, wherein the master chain code is generated based on a second portion of the hash of the seed value;
generating a master public corresponding to the master private key;
using a secret sharing scheme to make a respective share of the master private key available to each respective participant; and
making the master chain code available to each participant,
wherein each participant is configured to generate a respective share of a first child private key based on the respective share of the master private key, and a first portion of a hash of i) the master chain code, ii) the master public key and iii) a first key index.

15. A computer program embodied on non-transitory computer-readable storage media and configured so as, when run on one or more processors, the one or more processors perform a method of enabling participants of a group to generate shares of child private keys, and wherein the method is performed by a coordinator and comprises:
generating a master private key based on a first portion of a hash of a seed value;
generating a master chain code for the master private key, wherein the master chain code is generated based on a second portion of the hash of the seed value;
generating a master public corresponding to the master private key;
using a secret sharing scheme to make a respective share of the master private key available to each respective participant; and
making the master chain code available to each participant,
wherein each participant is configured to generate a respective share of a first child private key based on the respective share of the master private key, and a first portion of a hash of i) the master chain code, ii) the master public key and iii) a first key index.
